(19) United States
(12) Patent Application Publication
(10) Pub. No.: US 2014/0119166 A1
(43) Pub. Date: May 1, 2014

(54) System Circuit Board and Computer

(71) Applicants: INVENTEC (PUDONG) TECHNOLOGY CORPORATION, Shanghai (CN); INVENTEC CORPORATION, Taipei City (TW)

(72) Inventor: Hao-Yen KUAN, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/846,720

(22) Filed: Mar. 18, 2013

(30) Foreign Application Priority Data
Oct. 25, 2012 (CN) 201210414860.0

(51) Int. Cl. G11B 27/36

(52) U.S. Cl. CPC G11B 27/36
USPC 369/53.1

(57) ABSTRACT

A system circuit board and a computer are presented. The system circuit board includes a processor and a hard disk (HD) indicator circuit. The HD indicator circuit includes a first switch, a first light-emitting diode, a second switch, a second light-emitting diode, an inverting circuit, and a third light-emitting diode. The first switch is electrically connected between a first pin of the processor and the first light-emitting diode. The second switch is electrically connected between a second pin of the processor and the second light-emitting diode. The inverting circuit is connected between the second pin and the third light-emitting diode. Therefore, the second light-emitting diode and the third light-emitting diode share the second pin, so that the processor can execute more functions, and the number of resistors required by the HD indicator circuit is reduced.

### CROSS-REFERENCE TO RELATED APPLICATIONS

This non-provisional application claims priority under 35 U.S.C. § 119(a) on Patent Application No(s). 201210414860.0 filed in China on Oct. 25, 2012, the entire contents of which are hereby incorporated by reference.

### BACKGROUND OF THE INVENTION

1. Technical Field of the Invention

The disclosure relates to a system circuit board used for presenting an operational status of an electronic device, and more particularly to a system circuit board including a hard disk (HD) indicator circuit, and a computer.

2. Description of the Related Art

With the vigorous development of networks, the management of a network storage device becomes more important, and a network storage server may manage and control a Hard Disk (HD) in the following methods. In one method, a processor in a main system is directly used to manage and control an HD. In another method, a processor dedicated to management and control of an HD is added to a Serial Advanced Technology Attachment (SATA) backplane connected to the HD. In still another method, a monitoring device which is installed on a SATA backplane and is independent of a main system, is used to monitor multiple HDs connected to the SATA backplane. During the management and control of an HD, the status of the HD is displayed in a visualized manner by multiple light-emitting diodes connected to the processor.

A circuit for displaying an operational status of an HD generally uses three separated circuits to respectively control the on/off of light-emitting diodes with three different colors, and each of the circuits occupies a pin of a processor. For a 2.5-inch HD backplane, when the number of HDs is 24, all the pins of the processor is occupied. In this case, if a designer intends to add a control function to the processor (for example, add a function of determining the status of a Serial Attached SCSI (SAS) HD and the status of a SATA HD), the implementation fails because the pins of the processor are all occupied.

### SUMMARY OF THE INVENTION

A system circuit board disclosed by the disclosure comprises a processor and an HD indicator circuit. The HD indicator circuit comprises a first switch, a first light-emitting diode, a second switch, a second light-emitting diode, an inverting circuit, and a third light-emitting diode.

The first switch is electrically connected to a first pin of the processor, and is switched on or off according to a first control signal provided by the first pin. The first light-emitting diode is connected to the first switch, and used for emitting light when the first switch is switched on. The second switch is electrically connected to a second pin of the processor, and is switched on or off according to a second control signal provided by the second pin. The second light-emitting diode is connected to the second switch, and is used for emitting light when the second switch is switched on. The inverting circuit is connected to the second pin, and is used for inverting the second control signal. The third light-emitting diode is connected to the inverting circuit, and is used for determining whether to emit light or not, according to the inverted second control signal.

A computer disclosed by the disclosure comprises a system circuit board. The system circuit board comprises a processor and an HD indicator circuit. The HD indicator circuit comprises a first switch, a first light-emitting diode, a second switch, a second light-emitting diode, an inverting circuit, and a third light-emitting diode.

The first switch is electrically connected to a first pin of the processor, and is switched on or off according to a first control signal provided by the first pin. The first light-emitting diode is connected to the first switch, and is used for emitting light when the first switch is switched on. The second switch is electrically connected to a second pin of the processor, and is switched on or off according to a second control signal provided by the second pin. The second light-emitting diode is connected to the second switch, and is used for emitting light when the second switch is switched on. The inverting circuit is connected to the second pin, and is used for inverting the second control signal. The third light-emitting diode is connected to the inverting circuit, and is used for determining whether to emit light or not, according to the inverted second control signal.

### BRIEF DESCRIPTION OF THE DRAWINGS

The disclosure will become more fully understood from the detailed description given herein below for illustration only, and thus does not limit the disclosure, wherein:

FIG. 1 is a schematic structural view of an HD indicator circuit according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In this embodiment, a circuit used for presenting an operational status of an electronic device is disposed in a system circuit board. The system circuit board is disposed in a system device, and used for controlling and monitoring the operation of the electronic device in the system device.

In this embodiment and some other embodiments, the system device is a computer, the system circuit board is a motherboard, and the electronic device is a HD, but the disclosure is not limited thereby. The system circuit board presents an operational status of the HD in real time through an HD indicator circuit provided by the disclosure.

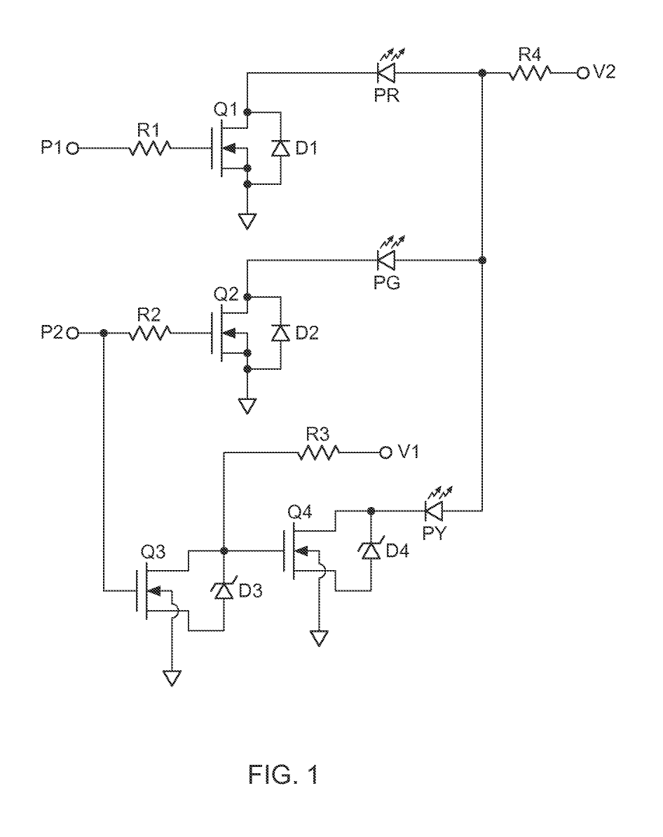

FIG. 1 is a schematic structural diagram of a HD indicator circuit according to an embodiment of the disclosure. The HD indicator circuit is disposed on a system circuit board, and connected to a processor on the system circuit board. The HD indicator circuit comprises resistors R1 and R2, a first switch Q1, a first light-emitting diode PR, a second switch Q2, a second light-emitting diode PG, an inverting circuit, a third light-emitting diode PY, and a common resistor R4.

In this embodiment and some other embodiments, the light emitted by the first light-emitting diode PR is red, the light emitted by the second light-emitting diode PG is green, and the light emitted by the third light-emitting diode PY is orange, but the disclosure is not limited thereby. In this embodiment and some other embodiments, the first switch Q1 and the second switch Q2 are, for example, transistors.

The gate of the first switch Q1 is connected to a first pin P1 of the processor through the resistor R1. The source of the first switch Q1 is grounded and connected to the anode of a diode D1. The drain of the first switch Q1 is connected to the cathode of the diode D1 and to the cathode of the first light-emitting diode PR. The anode of the first light-emitting diode PR is connected to one end of the common resistor R4. The another end of the common resistor R4 is connected to a second power supply terminal V2. The first switch Q1 is switched on according to the status of a first control signal provided by the first pin P1.

The gate of the second switch Q2 is connected to a second pin P2 of the processor through the resistor R2. The source of the second switch Q2 is grounded and connected to the anode of a diode D2. The drain of the second switch Q2 is connected to the cathode of the diode D2 and to the cathode of the second light-emitting diode PG. The anode of the second light-emitting diode PG is connected to the common resistor R4. The second switch Q2 is switched on according to the status of a second control signal provided by the second pin P2.

The inverting circuit comprises a resistor R3, diodes D3 and D4, a third switch Q3, and a fourth switch Q4, and is used for inverting the second control signal provided by the second pin P2. In this embodiment and some other embodiments, the third switch Q3 and the fourth switch Q4 are, for example, transistors. In this embodiment and some other embodiments, the diodes D3 and D4 are, for example, Zener diodes.

The gate of the third switch Q3 is connected to the second pin P2. The base of the third switch Q3 is grounded. The source of the third switch Q3 is connected to the anode of the Zener diode D3. The drain of the third switch Q3 is connected to the cathode of the Zener diode D3, to one end of the resistor R3, and to the gate of the fourth switch Q4. The other end of the resistor R3 is connected to a first power supply terminal V1. The base of the fourth switch Q4 is grounded. The source of the fourth switch Q4 is connected to the anode of the Zener diode D4. The drain of the fourth switch Q4 is connected to the cathode of the Zener diode D4 and to the cathode of the third light-emitting diode PY. The anode of the third light-emitting diode PY is connected to the common resistor R4.

When the status of the first control signal provided by the first pin P1 is at a high level, the first switch Q1 is switched on, and a current flows from the second power supply terminal V2 to the first light-emitting diode PR through the first light-emitting diode PR to drive the first light-emitting diode PR to emit light. When the status of the first control signal provided by the first pin P1 is at a low level, the first switch Q1 is switched off, and no current flows from the second power supply terminal V2 to the first light-emitting diode PR through the first light-emitting diode PR. Herein, the first light-emitting diode PR does not emit light.

When the status of the second control signal provided by the second pin P2 is at a high level, the second switch Q2 is switched on, and a current flows from the second power supply terminal V2 to the second light-emitting diode PG through the second light-emitting diode PG to drive the second light-emitting diode PG to emit light. Herein, the third switch Q3 and the fourth switch Q4 are switched off, so that the third light-emitting diode PY does not emit any light.

When the status of the second control signal provided by the second pin P2 is at a low level, the second switch Q2 is switched off Herein, no current flows from the second power supply terminal V2 to the second light-emitting diode PG through the second light-emitting diode PG, so that the second light-emitting diode PG does not emit light. In this case, the third switch Q3 and the fourth switch Q4 are switched on, and a current flows from the second power supply terminal V2 to the third light-emitting diode PY through the third light-emitting diode PY to drive the third light-emitting diode PY.

Through the foregoing operations, the computer can use the three light-emitting diodes to notify users the operation status of the HD. The detailed notification manner is described as follows.

When detecting no HD, the processor turns off the first light-emitting diode PR, the second light-emitting diode PG, and the third light-emitting diode PY.

When detecting that an HD exits, the processor switches the second light-emitting diode PG on, and turns off the third light-emitting diode PY. Simultaneously, the first light-emitting diode PR operates according to the status of the first pin P1.

When detecting that the HD operates inappropriately or is interrupted during rebuilding, the processor turns off the second light-emitting diode PG, and switches the third light-emitting diode PY on. Simultaneously, the first light-emitting diode PR operates according to the status of the first pin P1.

When detecting that the HD is being rebuilt, the processor switches the first light-emitting diode PR and the second light-emitting diode PG on alternately. For example, the second light-emitting diode PG is switched on for 400 micro-seconds (ms) while the third light-emitting diode PY is turned off for 400 micro-seconds. The first light-emitting diode PR operates according to the status of the first pin P1. Afterward, the second light-emitting diode PG is turned off for 100 ms, while the third light-emitting diode PY is switched on for 100 micro-seconds. The first light-emitting diode PR operates according to the status of the first pin P1.

When detecting that the HD is successfully installed, the processor alternately switches on the second light-emitting diode PG and the third light-emitting diode PY in a way different from that in the rebuilding of the HD. For example, the second light-emitting diode PG is switched on for 250 ms while the third light-emitting diode PY is turned off for 250 ms. Afterward, the processor turns off the second light-emitting diode PG for 250 ms while switches the third light-emitting diode PY on for 250 ms. The first light-emitting diode PR operates according to the status of the first pin P1.

The status of the first pin P1 changes according to the operational status of the HD. The above embodiments are not intended to limit the disclosure.

In this example, a voltage value of the first power supply terminal V1 is smaller than a voltage value of the second power supply terminal V2.

Through the inverting circuit, the second light-emitting diode PG and the third light-emitting diode PY are capable of sharing one pin of the processor. Therefore, the processor can spare one pin for performing other control functions, and the number of resistors required in the circuit used for presenting an operational status of an electronic device is reduced as compared with the case that the light-emitting diodes are connected one-to-one to the pins of the processor.

Further, through the common resistor R4, the number of resistors required when the light-emitting diodes are connected to the first power supply terminal, is reduced in the circuit for presenting an operational status of an electronic device.

The disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system circuit board, comprising:
a processor; and
a hard disk indicator circuit comprising:
a first switch, electrically connected to a first pin of the processor, for switched on or off according to a first control signal provided by the first pin;
a first light-emitting diode, connected to the first switch, for emitting light when the first switch is switched on;
a second switch, electrically connected to a second pin of the processor, for switched on or off according to a second control signal provided by the second pin;
a second light-emitting diode, connected to the second switch, for emitting light when the second switch is switched on;
an inverting circuit, connected to the second pin, for inverting the second control signal; and
a third light-emitting diode, connected to the inverting circuit, for determining whether to emit light or not, according to the inverted second control signal.

2. The system circuit board according to claim 1, wherein the inverting circuit comprises:
a third switch, connected to the second pin; and
a fourth switch, connected between the third switch and the third light-emitting diode.

3. The system circuit board according to claim 2, wherein a gate of the third switch is connected to the second pin, a source of the third switch is grounded, a drain of the third switch is electrically connected to a first power supply terminal, a gate of the fourth switch is connected to the drain of the third switch, a source of the fourth switch is grounded, and a drain of the fourth switch is connected to the third light-emitting diode.

4. The system circuit board according to claim 3, further comprising:
a common resistor, connected to the first light-emitting diode, the second light-emitting diode, and the third light-emitting diode.

5. The system circuit board according to claim 4, wherein the common resistor is connected to a second power supply terminal, and a voltage value of the second power supply terminal is greater than a voltage value of the first power supply terminal.

6. A computer, comprising:
a system circuit board comprising a processor and a hard disk indicator circuit, and the hard disk indicator circuit comprising:
a first switch, electrically connected to a first pin of the processor, for switched on or off according to a first control signal provided by the first pin;
a first light-emitting diode, connected to the first switch, for emitting light when the first switch is switched on;
a second switch, electrically connected to a second pin of the processor, for switched on or off according to a second control signal provided by the second pin;
a second light-emitting diode, connected to the second switch, for emitting light when the second switch is switched on;
an inverting circuit, connected to the second pin, for inverting the second control signal; and
a third light-emitting diode, connected to the inverting circuit, for determining whether to emit light or not, according to the inverted second control signal.

7. The computer according to claim 6, wherein the inverting circuit comprises:
a third switch, connected to the second pin; and
a fourth switch, connected between the third switch and the third light-emitting diode.

8. The computer according to claim 7, wherein a gate of the third switch is connected to the second pin, a source of the third switch is grounded, a drain of the third switch is electrically connected to a first power supply terminal, a gate of the fourth switch is connected to the drain of the third switch, a source of the fourth switch is grounded, and a drain of the fourth switch is connected to the third light-emitting diode.

9. The computer according to claim 8, further comprising:
a common resistor, connected to the first light-emitting diode, the second light-emitting diode, and the third light-emitting diode.

10. The computer according to claim 9, wherein the common resistor is connected to a second power supply terminal, and a voltage value of the second power supply terminal is greater than a voltage value of the first power supply terminal.
